(19) United States
(12) Patent Application Publication
(10) Pub. No.: US 2017/0187068 A1
(43) Pub. Date: Jun. 29, 2017

(54) NON-AQUEOUS ELECTROLYTE SECONDARY CELL

(71) Applicant: Panasonic Corporation, Osaka (JP)

(72) Inventors: NAOYA MORISAWA, Hyogo (JP); TAKANOBU CHIGA, Osaka (JP); ATSUSHI FUKUI, Hyogo (JP)

(21) Appl. No.: 15/357,957

(22) Filed: Nov. 21, 2016

(30) Foreign Application Priority Data
Dec. 25, 2015 (JP) 2015-254632

(51) Int. Cl. H01M 10/0565; H01M 10/0525; H01M 4/131; H01M 4/38; H01M 4/525; H01M 4/505; H01M 4/62; H01M 4/583; H01M 2/02; H01M 4/66

(52) U.S. Cl. CPC H01M 10/0565; H01M 2/022; H01M 2/0237; H01M 2/0252; H01M 10/0525; H01M 4/131; H01M 4/661; H01M 4/525; H01M 4/505; H01M 4/625; H01M 4/626; H01M 4/623; H01M 4/583; H01M 4/38; H01M 2300/0025; H01M 2300/0082; H01M 2220/10; H01M 2220/20; H01M 2220/30

(57) ABSTRACT

A non-aqueous electrolyte secondary cell includes: a positive electrode including a positive electrode active material which contains as a primary component, a lithium composite oxide in which the rate of nickel to the total number of moles of metal elements other than lithium is 50 percent by mole or more; a negative electrode; and a non-aqueous electrolyte. The non-aqueous electrolyte contains lithium bis(fluorosulfonyl)amide and a fluorinated chain carboxylic acid ester represented by the following formula,

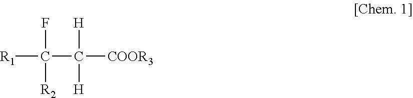

R₁ and R₂ each represent H, F, or CH₃₋ₓFₓ (x represents 1, 2, or 3) and may be equivalent to or different from each other. R₃ represents an alkyl group having 1 to 3 carbon atoms and may contain F.

### BACKGROUND

1. Technical Field

The present disclosure relates to a non-aqueous electrolyte secondary cell.

2. Description of the Related Art

Japanese Patent No. 5235437 has disclosed a non-aqueous electrolyte secondary cell containing as a solvent component of a non-aqueous electrolyte, fluoroethylene carbonate (FEC) and a fluorinated chain carboxylic acid ester. It has been disclosed that according to this non-aqueous electrolyte secondary cell, a decrease of a cell capacity under high-temperature conditions is small, and preferable high-temperature storage characteristic and cycle characteristic can be obtained.

### SUMMARY

As described above, although the high-temperature storage characteristic is improved when FEC and a fluorinated chain carboxylic acid ester are used for a non-aqueous electrolyte, when this non-aqueous electrolyte and a positive electrode including a positive electrode active material which has a high nickel (Ni) content rate are used in combination, a problem in that an initial charge/discharge efficiency of the cell is decreased may arise.

In one general aspect, the techniques disclosed here feature a non-aqueous electrolyte secondary cell comprising: a positive electrode including a positive electrode active material which contains as a primary component, a lithium composite oxide in which the rate of nickel to the total number of moles of metal elements other than lithium is 50 percent by mole or more; a negative electrode; and a non-aqueous electrolyte, and the non-aqueous electrolyte contains lithium bis(fluorosulfonyl)amide and a fluorinated chain carboxylic acid ester (fluorinated chain carboxylic acid ester having hydrogen at its a position) represented by the following general formula.

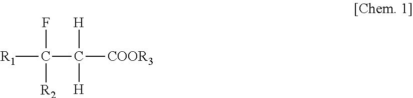

In the above formula, R₁ and R₂ each represent H, F, or CH₃₋ₓFₓ (x represents 1, 2, or 3) and may be equivalent to or different from each other. R₃ represents an alkyl group having 1 to 3 carbon atoms and may contain F.

According to the non-aqueous electrolyte secondary cell of one aspect of the present disclosure, a cycle characteristic is preferable, and a high initial charge/discharge efficiency can be obtained.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a perspective view showing the appearance of a non-aqueous electrolyte secondary cell of one example of an embodiment;

FIG. 2 is a cross-sectional view taken along the line II-II shown in FIG. 1;

FIG. 3 is a view showing an outside surface of a bottom portion of the non-aqueous electrolyte secondary cell of the example of the embodiment; and

FIG. 4 is a view showing an inside surface of the bottom portion of the non-aqueous electrolyte secondary cell of the example of the embodiment.

### DETAILED DESCRIPTION

In a non-aqueous electrolyte secondary cell, it has been known that a non-aqueous electrolyte component is partially decomposed in a first charge, and a film formed of a decomposition product derived therefrom is formed on a negative electrode surface. The negative electrode surface indicates an interface between a non-aqueous electrolyte and a negative electrode active material, each of which contributes to the reaction therebetween, that is, indicates the surface of the negative electrode active material. This film is also called a SEI (Solid Electrolyte Interface) forming film and has a preferable influence on cell characteristics.

However, when the film is excessively formed on the negative electrode surface by decomposition of the non-aqueous electrolyte, lithium (Li) inserted into the negative electrode in the first charge cannot be released, and the initial charge/discharge efficiency is decreased. The initial charge/discharge efficiency can be expressed by the following formula.

Initial charge/discharge efficiency (%)=(initial discharge capacity/initial charge capacity)×100

In the case in which a positive electrode active material having a high Ni content rate and containing a large amount of an alkali component is used, when a non-aqueous electrolyte contains a fluorinated chain carboxylic acid ester having hydrogen at its a position represented by the following general formula, the initial charge/discharge efficiency is decreased. The reason for this is believed that as shown by the following reaction formula (I), since a decomposition reaction occurs between the fluorinated chain carboxylic acid ester and the alkali component, such as lithium carbonate, contained in the positive electrode active material, H₂O and R₁R₂C═CHOOR₃, which are generated thereby, diffuse to a negative electrode side, and the film described above is excessively formed on the negative electrode surface. In particular, it is estimated that since the positive electrode active material having a high Ni content rate has a large amount of an alkali component, the decrease in initial charge/discharge efficiency is remarkable.

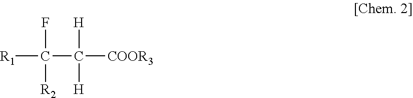

In the above formula, R₁ and R₂ each represent H, F, or CH₃₋ₓFₓ (x represents 1, 2, or 3) and may be equivalent to or different from each other. R₃ represents an alkyl group having 1 to 3 carbon atoms and may contain F.

[Chem. 3]

Li₂CO₃+2R₁R₂FCCH₂COOR₃→2LiF+CO₂+H₂O+2R₁R₂C═CHCOOR₃ Chemical reaction (I)

Through intensive research carried out by the present inventors to solve the above problem, it was found that when a fluorinated chain carboxylic acid ester having hydrogen at its a position and lithium bis(fluorosulfonyl)amide represented by the following general formula are used in combination, while a preferable cycle characteristic is maintained, the initial charge/discharge efficiency is improved. In addition, when the fluorinated chain carboxylic acid ester having hydrogen at its a position is contained in a non-aqueous electrolyte, as described above, the high-temperature storage characteristic is also improved.

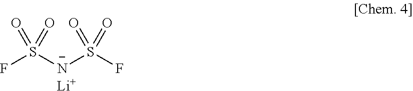

Incidentally, when a cell package can which is formed of a metal material containing iron (Fe) as a primary component is used, in order to prevent can corrosion, Ni plating has been generally performed; however, the present inventors have known that if a sulfur compound is contained in a non-aqueous electrolyte, can corrosion occurs in high-temperature over discharge. The reason this can corrosion occurs is believed that since a decomposition product derived from the sulfur compound reacts with Ni, Fe is exposed. It is believed that when an over discharge test is performed at a high temperature, since the package can is exposed to a potential of approximately 3 V with respect to a Li reference potential, at a portion at which the Ni plating is peeled away, Fe is eluted, and the can corrosion occurs thereby.

According to the non-aqueous electrolyte secondary cell of the present disclosure, the above can corrosion can be prevented. The reason for this is that since the fluorinated chain carboxylic acid ester contained in the non-aqueous electrolyte has hydrogen at its a position, decomposition of the above ester occurs as shown by the following chemical formula (II), and the film is formed on an inside surface of the package can. Since this film functions as a protective layer of the package can, it is believed that the above can corrosion can be suppressed. That is, this protective layer (protective film) suppresses the reaction between the decomposition product derived from the sulfur compound and Ni on the surface of the package can, and hence Fe is suppressed from being exposed. Accordingly, it is believed that even when an over discharge test is performed at a high temperature, Fe is not eluted, and the can corrosion can be suppressed.

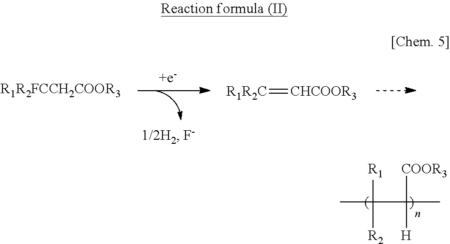

Hereinafter, with reference to the attached drawings, a non-aqueous electrolyte secondary cell, which is one example of the embodiment, will be described in detail. The drawings used for illustrating the embodiment are schematically drawn, and particular dimensions, ratios, and the like are to be appropriately understood in consideration of the following description.

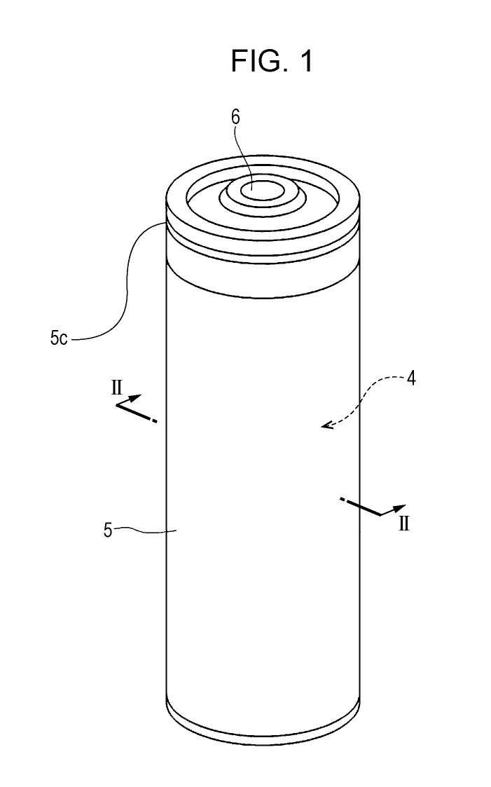

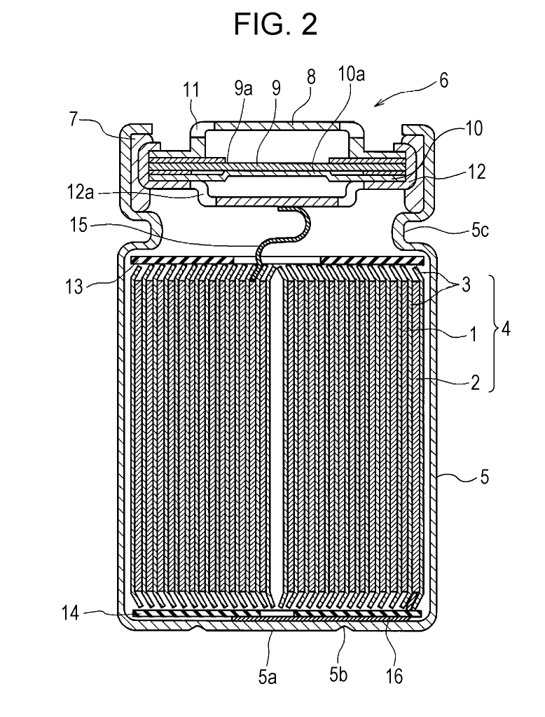

FIG. 1 is a perspective view showing the appearance of the non-aqueous electrolyte secondary cell, which is one example of the embodiment, and FIG. 2 is a cross-sectional view taken along the line II-II in FIG. 1. As shown in FIGS. 1 and 2 by way of example, the non-aqueous electrolyte secondary cell, which is one example of the embodiment, includes an electrode body 4, a non-aqueous electrolyte (not shown), and a package can 5 receiving the electrode body 4 and the non-aqueous electrolyte. The electrode body 4 has a structure in which, for example, a positive electrode 1 and a negative electrode 2 are wound around with at least one separator 3 provided therebetween. The package can 5 has, for example, a cylindrical shape having a bottom portion. At an upper portion of the package can 5, a groove portion 5c recessed toward the inside of the package can 5 is provided along a circumference direction thereof. At the portion at which the groove portion 5c is formed, an inside surface of the package can 5 protrudes, and a sealing body 6 is supported by this protruding portion and seals an opening portion of the package can 5. Between the package can 5 and the sealing body 6, a gasket 7 is preferably provided.

The sealing body 6 includes a cap 8, an upper valve 9, a lower valve 10, and a filter 12. The cap 8 has an exhaust hole 11 and functions as a positive electrode external terminal. In the filter 12, an opening portion 12a is formed. The upper valve 9 and the lower valve 10 are each broken when the inside pressure is increased by a gas generated by heat generation due to internal short circuit or the like and each function as a safety valve which discharges the gas out of the cell. The upper valve 9 and the lower valve 10 have a thin wall portion 9a and 10a, respectively, each of which is broken when the cell inside pressure reaches a predetermined value.

On the top and the bottom of the electrode body 4, insulating plates 13 and 14 are provided, respectively. A positive electrode lead 15 fitted to the positive electrode 1 extends to a sealing body 6 side via a through hole of the insulating plate 13, and a negative electrode lead 16 fitted to the negative electrode 2 extends to a bottom portion 5a side of the package can 5 along the outside of the insulating plate 14. The positive electrode lead 15 is connected to the filter 12 which is a bottom plate of the sealing body 6 by welding or the like. The negative electrode lead 16 is connected to the bottom portion 5a of the package can 5 by welding or the like. That is, the negative electrode 2 is electrically connected to the package can 5.

The package can 5 is formed, for example, of a metal material containing Fe as a primary component. On the inside surface of the package can 5, a Ni plating layer (not shown) is preferably formed in order to prevent the can corrosion. The thickness of the Ni plating layer is, for example, 2 μm or less and preferably 1 μm or less. In the non-aqueous electrolyte secondary cell of this embodiment, even if the thickness of the Ni plating layer is 1 μm or less, the can corrosion can be sufficiently suppressed.

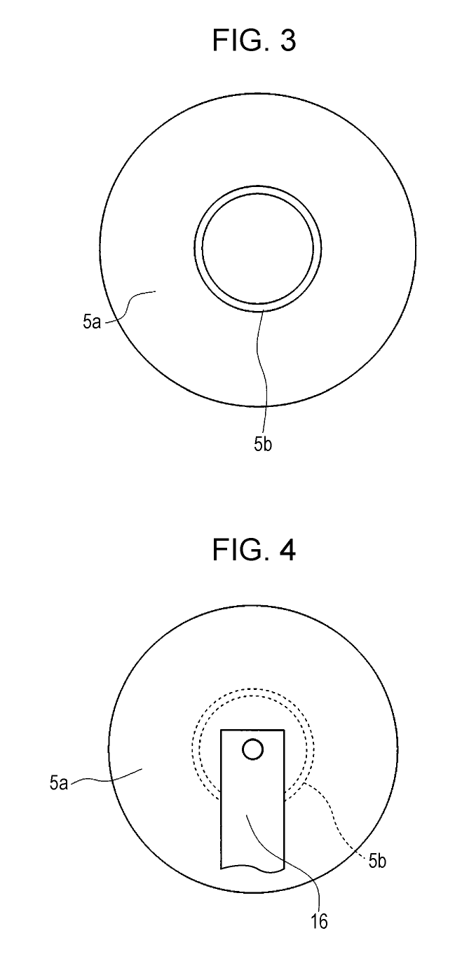

FIG. 3 is a view showing an outside surface of the bottom portion 5a of the package can 5. As shown in FIG. 3 by way of example, in the bottom portion 5a of the package can 5, an annular thin wall portion 5b which is to be broken when the cell inside pressure reaches a predetermined value is preferably formed. The thin wall portion 5b is, for example, a recess portion formed in the outside surface of the bottom portion 5a. The thin wall portion 5b is to be broken when the cell inside pressure is increased and prevents a side wall portion of the package can 5 from being broken. The inside pressure (operation pressure) at which the thin wall portion 5b is to be broken is, for example, set to be higher than the inside pressure at which the thin wall portion 9a formed in the upper valve 9 is broken.

FIG. 4 is a view showing an inside surface of the bottom portion 5a of the package can 5. As shown in FIG. 4 by way of example, when the thin wall portion 5b is formed in the bottom portion 5a of the package can 5, the negative electrode lead 16 is preferably welded to a region of the inside surface of the bottom portion 5a surrounded by the thin wall portion 5b. In general, the inside surface of the bottom portion 5a protrudes at a portion corresponding to the thin wall portion 5b. In addition, a black circle shown in FIG. 4 indicates a welding position at which the inside surface of the bottom portion 5a and the negative electrode lead 16 are welded to each other. Accordingly, an interference with the breakage of the thin wall portion 5b caused by the negative electrode lead 16 can be easily prevented.

In the inside surface of the bottom portion 5a of the package can 5, at the portion corresponding to the thin wall portion 5b, the thickness of the Ni plating layer is liable to be decreased. At the portion at which the thickness of the Ni plating layer is small, since the decomposition product derived from the sulfur compound reacts with Ni, Fe is liable to be eluted, and the can corrosion is liable to occur; however, according to the non-aqueous electrolyte secondary cell of this embodiment, the can corrosion at the portion as described above can also be sufficiently suppressed.

Hereinafter, the individual constituent elements of the non-aqueous electrolyte secondary cell, which is one example of the embodiment, will be described in detail.

### [Positive Electrode]

The positive electrode 1 is formed, for example, of a positive electrode collector, such as metal foil, and a positive electrode active material layer formed on the positive electrode collector. As the positive electrode collector, for example, there may be used metal foil stable in a potential range of the positive electrode 1 or a film having a surface layer on which a metal stable in a potential range of the positive electrode 1 is provided. As the metal stable in a potential range of the positive electrode 1, aluminum (Al) is preferably used. The positive electrode active material layer is a layer formed in such a way that after a positive electrode mixture slurry containing an electrically conductive agent, a binder, an appropriate solvent, and the like besides the positive electrode active material is applied on the positive electrode collector, drying and rolling are performed.

The positive electrode active material contains as a primary component, a lithium composite oxide (hereinafter, referred to as “composite oxide A” in some cases) in which the rate of Ni to the total number of moles of metal elements other than Li is 50 percent by mole or more. The primary component indicates a component having a largest content among the materials forming the positive electrode active material. The positive electrode active material may also contain, for example, a lithium composite oxide besides the composite oxide A. However, the composite oxide A is contained in an amount of preferably 50 percent by weight or more with respect to the total weight of the positive electrode active material and more preferably 80 percent by weight or more, and the content of the composite oxide A may also be 100 percent by weight. On the surfaces of particles of the positive electrode active material, fine particles of an inorganic compound, such as an oxide including aluminum oxide (Al₂O₃), or a compound containing a lanthanoid element, may be present.

The composite oxide A is preferably an oxide represented by general formula LiₓNi_{y}M_{(1-y)}O₂ (0.9≦x≦1.2, 0.5<y≦0.95, and M indicates at least one type of metal element). In addition, the above general formula represents the composition in a fully discharged state. In view of reduction in cost, the content rate of Ni to the total number of moles of metal elements other than Li is preferably 50 percent by mole or more and more preferably 80 percent by mole or more. In particular, although a positive electrode active material having a Ni content rate of 80 percent by mole or more can be expected to increase the capacity besides the reduction in cost, on the other hand, since the above positive electrode active material contains a large amount of an alkali component, as shown by the reaction formula (1), the decomposition of the fluorinated chain carboxylic acid ester may arise. Hence, there have been problems in that the initial charge/discharge efficiency is decreased, and the effect of increasing the capacity cannot be obtained. On the other hand, in the non-aqueous electrolyte secondary cell of the present disclosure, since lithium bis(fluorosulfonyl)amide selectively reacts with an alkali component and suppresses the reaction represented by the reaction formula (1), a positive electrode active material having a Ni content rate of 80 percent by mole or more can be used without decreasing the initial charge/discharge efficiency. The composite oxide A has a layered rock-salt type crystal structure.

The metal element M contained in the composite oxide A is, for example, at least one type selected from boron (B), magnesium (Mg), aluminum (Al), calcium (Ca), scandium (Sc), titanium (Ti), vanadium (V), chromium (Cr), manganese (Mn), iron (Fe), cobalt (Co), copper (Cu), zinc (Zn), gallium (Ga), germanium (Ge), yttrium (Y), zirconium (Zr), tin (Sn), antimony (Sb), lead (Pb), and bismuth (Bi). Among those mentioned above, the metal element M is preferably at least one type selected from Co, Mn, and Al. As a preferable composite oxide A, for example, a lithium/nickel/cobalt/aluminum composite oxide (NCA) or a lithium/nickel/cobalt/manganese composite oxide (NCM) may be mentioned.

The electrically conductive agent has a function to improve electron conductivity of the positive electrode active material layer. As the electrically conductive agent, for example, a carbon material, a metal powder, or an organic material, each of which has electrical conductivity, may be used. In particular, for example, there may be mentioned acetylene black, ketchen black, or graphite as the carbon material; aluminum as the metal powder; and a phenylene derivative as the organic material. Those electrically conductive agents may be used alone, or at least two types thereof may be used in combination.

The binder functions to maintain a preferable contact state between the positive electrode active material and the electrically conductive agent and to increase a binding property of the positive electrode active material or the like to the surface of the positive electrode collector. As the binder, for example, a fluorinated polymer or a rubber-type polymer may be used. In particular, for example, there may be mentioned a polytetrafluoroethylene (PTFE), a poly(vinylidene fluoride) (PVdF), or a modified polymer thereof as the fluorinated polymer; and an ethylene-propylene-isoprene copolymer or an ethylene-propylene-butadiene copolymer as the rubber-type polymer. The binder may be used together with a thickening agent, such as a carboxymethyl cellulose (CMC) or a poly(ethylene oxide) (PEO).

### [Negative Electrode]

The negative electrode 2 is formed, for example, of a negative electrode collector, such as metal foil, and a negative electrode active material layer formed on the negative electrode collector. As the negative electrode collector, for example, there may be used metal foil forming no alloy with lithium in a potential range of the negative electrode 2 or a film having a surface layer on which a metal forming no alloy with lithium in a potential range of the negative electrode 2 is provided. As the metal forming no alloy with lithium in a potential range of the negative electrode 2, copper (Cu) which is available at a low cost, which is likely to be processed, and which has good electron conductivity is preferably used. The negative electrode active material layer is a layer formed, for example, in such a way that after a negative electrode mixture slurry containing a binder, an appropriate solvent, and the like besides the negative electrode active material is applied on the negative electrode collector, drying and rolling are performed.

The negative electrode active material is not particularly limited as long as the material is able to occlude and release lithium ions. As the negative electrode active material, for example, there may be used a carbon material, a metal, an alloy, a metal oxide, or a metal nitride, or there may also be used carbon, silicon, or the like, in each of which lithium ions are occluded in advance. As the carbon material, for example, a natural graphite, an artificial graphite, or pitch-based carbon fibers may be mentioned. As a particular example of the metal or the alloy, for example, Li, silicon (Si), Sn, Ga, Ge, indium (In), a lithium alloy, a silicon alloy, or a tin alloy may be mentioned. The negative electrode active materials may be used alone, or at least two types thereof may be used in combination.

As the binder, although a fluorinated polymer, a rubber-type polymer, or the like may be used as is the case of the positive electrode 1, a styrene-butadiene copolymer (SBR) which is a rubber-type polymer or a modified polymer thereof is preferably used. The binder may also be used together with a thickening agent, such as a CMC.

### [Separator]

The separator 3 is arranged between the positive electrode 1 and the negative electrode 2, and as the separator 3, a porous film having ion permeability and insulating properties is used. As the porous film, for example, a fine porous thin film, a woven cloth, a non-woven cloth, or the like may be mentioned. As a material used for the separator, for example, a polyolefin may be mentioned, and in more particular, a polyethylene or a polypropylene is preferable.

### [Non-Aqueous Electrolyte]

The non-aqueous electrolyte contains a non-aqueous solvent and an electrolytic salt dissolved therein. The non-aqueous electrolyte contains as a non-aqueous solvent, at least a fluorinated chain carboxylic acid ester having hydrogen at its a position represented by the following general formula. In addition, the non-aqueous electrolyte contains lithium bis(fluorosulfonyl)amide (LiFSA). LiFSA functions as an electrolytic salt. In the non-aqueous electrolyte, since the fluorinated chain carboxylic acid ester and LiFSA are used in combination, a non-aqueous electrolyte secondary cell having a preferable cycle characteristic and a high initial charge/discharge efficiency can be obtained.

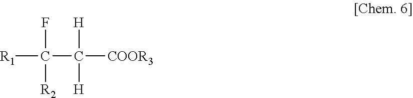

In the above formula, R₁ and R₂ each represent H, F, or CH₃₋ₓFₓ (x represents 1, 2, or 3) and may be equivalent to or different from each other. R₃ represents an alkyl group having 1 to 3 carbon atoms and may contain F.

As the fluorinated chain carboxylic acid ester, methyl 3,3,3-trifluoropropionate (FMP) is preferable since having a low viscosity and high electrical conductivity. The content of the fluorinated chain carboxylic acid ester with respect to the total volume of the non-aqueous solvent in the non-aqueous electrolyte is preferably 50 percent by volume or more and particularly preferably 70 percent by volume or more. When the content of the fluorinated chain carboxylic acid ester is set to 50 percent by volume or more, while the function of the non-aqueous solvent is maintained, a preferable protective film is likely to be formed on the negative electrode surface.

In addition, it has been known that the fluorinated chain carboxylic acid ester is decomposed on the negative electrode surface by reduction at approximately 1.2 V with respect to a Li reference potential (see Japanese Unexamined Patent Application Publication No. 2009-289414). Hence, in order to prevent excessive decomposition by the reduction as described above, a film forming compound which forms a film capable of suppressing the decomposition on the negative electrode surface is preferably added to the non-aqueous solvent.

The non-aqueous electrolyte preferably contains as the non-aqueous solvent, fluoroethylene carbonate (FEC). When FEC is added to the non-aqueous electrolyte, the film suppressing the decomposition of the fluorinated chain carboxylic acid ester by reduction is likely to be formed on the negative electrode surface, and the cycle characteristic is further improved. The content of FEC is preferably 2 to 40 percent by volume with respect to the total volume of the non-aqueous solvent and particularly preferably 5 to 30 percent by volume. When the volume of FEC is excessive, the viscosity of the non-aqueous electrolyte is increased, and load characteristics may be degraded in some cases.

The non-aqueous electrolyte may also contain, besides the fluorinated chain carboxylic acid ester and FEC, another non-aqueous solvent. As the another non-aqueous solvent, for example, there may be used an ester, such as ethylene carbonate (EC), propylene carbonate (PC), dimethyl carbonate (DMC), methyl ethyl carbonate (EMC), diethyl carbonate (DEC), methyl acetate, ethyl acetate, propyl acetate, or methyl propionate (MP); an ether, such as 1,3-dioxolane; a nitrile, such as acetonitrile; an amide such as dimethylformamide; or a mixed solvent containing at least two types of the solvents mentioned above. In addition, as the another non-aqueous solvent, a fluorinated solvent may also be used.

LiFSA suppresses the reaction between an alkali component in the positive electrode and the fluorinated chain carboxylic acid ester and improves the initial charge/discharge efficiency. The content of LiFSA with respect to the total volume of the non-aqueous electrolyte is preferably 0.02 to 2.0 M (mole/liter), more preferably 0.1 to 1.5 M, and particularly preferably 0.5 to 1.2 M. When the amount of LiFSA is excessively small, the effect of suppressing the decomposition reaction of the fluorinated chain carboxylic acid ester may not be sufficiently obtained. On the other hand, when the amount of LiFSA is excessively large, the viscosity of the non-aqueous electrolyte is increased, and the load characteristics may be degraded in some cases.

In a general electrolytic solution which does not contain the fluorinated chain carboxylic acid ester described above, when 0.5 M or more of LiFSA is added, in association with charge/discharge cycles, Al used as a positive electrode collector is dissolved, and as a result, a long-term reliability is disadvantageously degraded. On the other hand, when the above fluorinated chain carboxylic acid ester is used, since the electron density of the carbonyl oxygen is decreased by fluorination, the interaction with Al ions is decreased, and as a result, the dissolution of Al can be suppressed. Hence, when the fluorinated chain carboxylic acid ester of the present disclosure is used as a non-aqueous solvent, LiFSA having a concentration of 0.5 M or more can be used.

As described above, when a sulfur compound, such as LiFSA, is contained in a non-aqueous electrolyte, corrosion of an iron-made package can on which Ni plating is performed is liable to occur in high-temperature over discharge; however, when the fluorinated chain carboxylic acid ester is contained in the non-aqueous electrolyte, the can corrosion can be suppressed. The reason for this is believed that since a film derived from the decomposition product of the fluorinated chain carboxylic acid ester is formed on the inside surface of the package can, the reaction between the decomposition product derived from LiFSA and Ni can be suppressed.

The non-aqueous electrolyte may also contain a lithium salt besides LiFSA. As the lithium salt to be used together with LiFSA, for example, there may be mentioned LiBF₄, LiClO₄, LiPF₆, LiAsF₆, LiSbF₆, LiAlCl₄, LiSCN, LiCF₃SO₃, LiCF₃CO₂, Li(P(C₂O₄)F₄), LiPF₆₋ₓ(CₙF₂ₙ₊₁)ₓ (1<x<6, and n represents 1 or 2), LiCl, LiBr, Lil, chroloborane lithium, a lithium lower aliphatic carbonate, a boric acid salt, such as Li₂B₄O₇, or Li(B(C₂O₄)F₂), or a sulfonylamide salt, such as LiN(SO₂CF₃)₂, or LiN(CₗF₂ₗ₊₁SO₂)(CₘF₂ₘ₊₁SO₂) {l and m each represent an integer of 1 or more}. Among those mentioned above, in view of ion conductivity, electrochemical stability, and the like, LiPF₆ is preferably used.

The concentration of the lithium salt including LiFSA is preferably set to 0.8 to 1.8 moles (0.8 to 1.8 M) per one liter of the non-aqueous solvent. When LiFSA and another lithium salt are used together, the content of LiFSA with respect to the total number of moles of the lithium salts is, for example, 10 to 90 percent by mole and preferably 40 to 80 percent by mole.

The non-aqueous electrolyte may also contain an additive, such as vinylene carbonate (VC), ethylene sulfite (ES), lithium bis(oxalato)borate (LiBOB), cyclohexyl benzene (CHB), or ortho-terphenyl (OTP). Among those mentioned above, VC is preferably used. Since VC is likely to be decomposed on the negative electrode surface and is allowed to react in cooperation with the decomposition reaction of the fluorinated chain carboxylic acid ester, by addition of VC, a dense composite film can be formed in cooperation with the fluorinated chain carboxylic acid ester. The content of the additive may be set so that a sufficient film may be formed and is preferably 3 percent by mass or less with respect to the total mass of the non-aqueous electrolyte. The additives may be used alone, or at least two types thereof may be used in combination.

### EXAMPLES

Hereinafter, although the present disclosure will be described in more detail with reference to examples, the present disclosure is not limited to the following examples.

### Example 1

### [Formation of Positive Electrode]

As a positive electrode active material, a lithium-containing transition metal oxide represented by LiNi_{0.82}Co_{0.15}Al_{0.03}O₂ (NCA) was used. A positive electrode mixture slurry was prepared in such a way that after the above active material, acetylene black, and a poly(vinylidene fluoride) were mixed together so as to have a mass ratio of 100:1:0.9, an appropriate amount of N-methyl-2-pyrrolidone (NMP) was added thereto. Subsequently, this positive electrode mixture slurry was applied to two surfaces of a positive electrode collector formed of aluminum foil. After the coating films thus obtained were dried, rolling was performed using a rolling roller, so that a positive electrode in which positive electrode active material layers were formed on the two surfaces of the positive electrode collector was formed. The packing density of the positive electrode was 3.7 g/cm³.

### [Formation of Negative Electrode]

An artificial graphite, a sodium salt of a carboxymethyl cellulose (CMC-Na), and a styrene-butadiene copolymer (SBR) were mixed together in an aqueous solution at a mass ratio of 100:1:1, so that a negative electrode mixture slurry was prepared. Subsequently, this negative electrode mixture slurry was uniformly applied to two surfaces of a negative electrode collector formed of copper foil. After the coating films thus obtained were dried, rolling was performed using a rolling roller, so that a negative electrode in which negative electrode mixture layers were formed on the two surfaces of the negative electrode collector was formed. The packing density of the negative electrode is 1.7 g/cm³.

### [Preparation of Non-Aqueous Electrolyte]

Lithium bis(fluorosulfonyl)amide (LiFSA) was dissolved in a mixed solvent in which fluoroethylene carbonate (FEC) and methyl 3,3,3-trifluoropropionate (FMP) were mixed at a volume ratio of 15:85 to have a concentration of 1.2 M, so that a non-aqueous electrolyte was prepared.

### [Formation of Package Can]

Drawing was performed on an iron-made plate having a surface processed by Ni plating, so that a cylindrical package can having a bottom portion was formed. At an upper portion of the package can, a groove portion having a width of 1.0 mm, a depth of 1.5 mm, and an approximately U shape cross-sectional shape was formed in a side wall portion along the circumference direction. The thickness of the side wall portion and the thickness of the bottom portion of the package can were each set to 0.25 mm and 0.3 mm, respectively. In addition, the diameter of the bottom portion was set to 18 mm. From the result obtained by SEM observation, the thickness of a Ni plating layer formed on the inside surface of the bottom portion of the package can was 2 μm or less.

### [Formation of Cell]

The above positive electrode and the above negative electrode were wound around with at least one separator which was a fine porous polyethylene-made film, so that a wound-type electrode body was formed. After this electrode body was received in the above package can, and the non-aqueous electrolyte described above was filled therein, an opening portion of the package can was sealed by a sealing body with a gasket provided therebetween, a 18650 cylindrical type non-aqueous electrolyte secondary cell having a design capacity of 3,250 mAh was formed. In addition, the positive electrode was welded to a filter of the sealing body with a positive electrode lead provided therebetween, and the negative electrode was welded to the bottom portion of the package can with a negative electrode lead provided therebetween.

The initial charge/discharge efficiency, the high-temperature cycle characteristic, and the high-temperature over discharge test (can corrosion) of the cell described above were evaluated, and the evaluation results are shown in Table.

### [Evaluation of Initial Charge/Discharge Efficiency]

Constant current charge was performed at 650 mA [0.2 lt] at an environmental temperature of 25° C. until the cell voltage reached 4.2 V, and furthermore, constant voltage charge was performed at a voltage of 4.2 V until the current reached 65 mA. After a rest for 10 minutes was taken, discharge was performed at 650 mA [0.2 lt] until the cell voltage reached 2.5 V, and subsequently, a rest for 20 minutes was taken. The initial charge/discharge efficiency can be obtained by the following formula.

Initial charge/discharge efficiency=(initial discharge capacity/initial charge capacity)×100

### [Evaluation of High-Temperature Cycle Characteristic]

Charge and discharge were repeatedly performed 600 times at an environmental temperature of 45° C. under the same charge/discharge conditions as those of the test performed for obtaining the initial charge/discharge efficiency, and a capacity retention rate after 600 cycles was calculated using the following formula.

Capacity retention rate=(discharge capacity at 600^{th} cycle/discharge capacity at first cycle)×100

### [High-Temperature Over Discharge Test]

In an outside short circuit state in which a ceramic resistor was connected to the positive electrode and the negative electrode of the cell, the cell was placed in a constant-temperature bath at 60° C. for 20 days, and the state of the cell (package can) was then observed.

### Example 2

Except that a non-aqueous electrolyte was prepared by dissolving LiFSA and LiPF₆ in the non-aqueous solvent at concentrations of 0.5 M and 0.7 M, respectively, a cell was formed in a manner similar to that of Example 1, and the above evaluations were performed.

### Example 3

Except that a non-aqueous electrolyte was prepared by dissolving LiFSA and LiPF₆ in the non-aqueous solvent at concentrations of 0.2 M and 1.0 M, respectively, a cell was formed in a manner similar to that of Example 1, and the above evaluations were performed.

### Example 4

Except that as the positive electrode active material, instead of using LiNi_{0.82}Co_{0.15}Al_{0.03}O₂ (NCA), a lithium-containing transition metal oxide represented by LiNi_{0.50}Co_{0.20}Mn_{0.30}O₂ (NCM) was used, a cell was formed in a manner similar to that of Example 1. In addition, by changing the current in charge/discharge to 460 mA, the above evaluations were performed based on a cell design capacity of 2,300 mAh.

### Comparative Example 1

Except that in the preparation of a non-aqueous electrolyte, LiPF₆ was used instead of LiFSA, a cell was formed in a manner similar to that of Example 1, and the above evaluations were performed.

### Comparative Example 2

Except that in the preparation of a non-aqueous electrolyte, methyl ethyl carbonate (EMC) was used instead of FMP, a cell was formed in a manner similar to that of Example 3, and the above evaluations were performed.

### Comparative Example 3

Except that in the preparation of a non-aqueous electrolyte, EMC was used instead of FMP, a cell was formed in a manner similar to that of Comparative Example 1, and the above evaluations were performed.

### Comparative Example 4

Except that in the preparation of a non-aqueous electrolyte, ethylene carbonate (EC) was used instead of FEC, a cell was formed in a manner similar to that of Comparative Example 2, and the above evaluations were performed.

### Comparative Example 5

Except that in the preparation of a non-aqueous electrolyte, EC was used instead of FEC, a cell was formed in a manner similar to that of Comparative Example 3, and the above evaluations were performed.

### Comparative Example 6

Except that as the positive electrode active material, instead of using LiNi_{0.82}Co_{0.15}Al_{0.03}O₂ (NCA), a lithium-containing transition metal oxide represented by LiNi_{0.50}Co_{0.20}Mn_{0.30}O₂ (NCM) was used, a cell was formed in a manner similar to that of Comparative Example 1, and the above evaluations were performed.

TABLE

| | | | | | | High- |
|---|---|---|---|---|---|---|
| | | | | Initial Charge/ | Capacity | Temperature |
| | | | Non- | Discharge | Retention | Over |
| | Positive | | Aqueous | Efficiency | Rate | Discharge |
| | Electrode | Lithium Salt | Solvent | (%) | (%) | For 20 days |
| Example 1 | NCA | 1.2M LiFSA | FEC/FMP | 90 | 91 | No Change |
| Example 2 | | 0.7M LiPF₆ + 0.5M LiFSA | | 89 | 90 | No Change |
| Example 3 | | 1.0M LiPF₆ + 0.2M LiFSA | | 88 | 89 | No Change |
| Comparative | | 1.2M LiPF₆ | | 84 | 87 | No Change |
| Example 1 | | | | | | |
| Comparative | | 1.0M LiPF₆ + 0.2M LiFSA | FEC/EMC | 88 | 83 | Can |
| Example 2 | | | | | | Corrosion |
| Comparative | | 1.2M LiPF₆ | | 88 | 82 | No Change |
| Example 3 | | | | | | |
| Comparative | | 1.0M LiPF₆ + 0.2M LiFSA | EC/EMC | 86 | 69 | Can |
| Example 4 | | | | | | Corrosion |
| Comparative | | 1.2M LiPF₆ | | 86 | 68 | No Change |
| Example 5 | | | | | | |
| Example 4 | NCM | 1.0M LiPF₆ + 0.2M LiFSA | FEC/FMP | 87 | 90 | No Change |
| Comparative | | 1.2M LiPF₆ | | 85 | 89 | No Change |
| Example 6 | | | | | | |

As shown in Table, in all the cells of Examples, a preferable high-temperature cycle characteristic (high capacity retention rate) and a high initial charge/discharge efficiency could be obtained. In addition, in all the cells of Examples, no corrosion of the package can was confirmed in the high-temperature over discharge test. On the other hand, in the cells of Comparative Examples, the capacity retention rate or the initial charge/discharge efficiency was low, and those two characteristics could not be simultaneously satisfied. In addition, in the cells of Comparative Examples 2 and 4 in each of which LiFSA was added to and no FMP was contained in the non-aqueous electrolyte, corrosion of the package can was confirmed in the high-temperature over discharge test. That is, only in the case in which a fluorinated chain carboxylic acid ester having hydrogen at its a position and LiFSA are both contained in the non-aqueous electrolyte, a preferable cycle characteristic and a high initial charge/discharge efficiency can be obtained without generating the corrosion of the package can.

The non-aqueous electrolyte secondary cell of the present disclosure is not limited to that of the above embodiment and, for example, may also include the following configurations.

### [Item 1]

A non-aqueous electrolyte secondary cell comprises: a positive electrode including a positive electrode active material which contains as a primary component, a lithium composite oxide in which the rate of nickel to the total number of moles of metal elements other than lithium is 50 percent by mole or more; a negative electrode; and a non-aqueous electrolyte, and the non-aqueous electrolyte contains lithium bis(fluorosulfonyl)amide and a fluorinated chain carboxylic acid ester represented by the following formula,

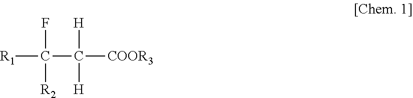

(In the above formula, R₁ and R₂ each represent H, F, or CH₃₋ₓFₓ (x represents 1, 2, or 3) and is equivalent to or different from each other. R₃ represents an alkyl group having 1 to 3 carbon atoms and may contain F.)

### [Item 2]

In the non-aqueous electrolyte secondary cell according to Item 1, the non-aqueous electrolyte contains fluoroethylene carbonate.

### [Item 3]

In the non-aqueous electrolyte secondary cell according to Item 1 or 2, the fluorinated chain carboxylic acid ester includes methyl 3,3,3-trifluoropropionate.

### [Item 4]

In the non-aqueous electrolyte secondary cell according to any one of Items 1 to 3, the content of the fluorinated chain carboxylic acid ester with respect to the total volume of a non-aqueous solvent in the non-aqueous electrolyte is 70 percent by volume or more.

### [Item 5]

In the non-aqueous electrolyte secondary cell according to any one of Items 1 to 4, the content of lithium bis(fluorosulfonyl)amide with respect to the total volume of the non-aqueous electrolyte is 0.02 to 2.0 M.

### [Item 6]

In the non-aqueous electrolyte secondary cell according to any one of Items 1 to 5, in the lithium composite oxide, the rate of Ni to the total number of moles of metal elements other than lithium is 80 percent by mole or more.

### [Item 7]

The non-aqueous electrolyte secondary cell according to any one of Items 1 to 6 further comprises a package can which is formed of a metal material containing iron as a primary component and which receives the positive electrode, the negative electrode, and the non-aqueous electrolyte.

### [Item 8]

In the non-aqueous electrolyte secondary cell according to Item 7, the package can has an inside surface which is provided with a nickel plating layer, and the thickness of the nickel plating layer is 1 μm or less.

### [Item 9]

In the non-aqueous electrolyte secondary cell according to Item 1, R₁ and R₂ are the same.

### [Item 10]

In the non-aqueous electrolyte secondary cell according to Item 1, R₁ and R₁ is different from R₂.

### [Item 10]

In the non-aqueous electrolyte secondary cell according to Item 1, R₃ contains F.

What is claimed is:

1. A non-aqueous electrolyte secondary cell comprising:
a positive electrode including a positive electrode active material which contains as a primary component, a lithium composite oxide in which the rate of nickel to the total number of moles of metal elements other than lithium is 50 percent by mole or more;
a negative electrode; and
a non-aqueous electrolyte,
wherein the non-aqueous electrolyte contains lithium bis(fluorosulfonyl)amide and a fluorinated chain carboxylic acid ester represented by the following formula, 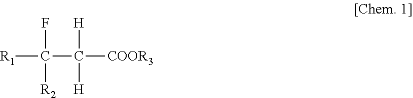
where R₁ and R₂ each represent H, F, or CH₃₋ₓFₓ (x represents 1, 2, or 3). R₃ represents an alkyl group having 1 to 3 carbon atoms.

2. The non-aqueous electrolyte secondary cell according to claim 1,
wherein the non-aqueous electrolyte contains fluoroethylene carbonate.

3. The non-aqueous electrolyte secondary cell according to claim 1,
wherein the fluorinated chain carboxylic acid ester includes methyl 3,3,3-trifluoropropionate.

4. The non-aqueous electrolyte secondary cell according to claim 1,
wherein the content of the fluorinated chain carboxylic acid ester with respect to the total volume of a non-aqueous solvent in the non-aqueous electrolyte is 70 percent by volume or more.

5. The non-aqueous electrolyte secondary cell according to claim 1,
wherein the content of lithium bis(fluorosulfonyl)amide with respect to the total volume of the non-aqueous electrolyte is 0.02 to 2.0 M.

6. The non-aqueous electrolyte secondary cell according to claim 1,
wherein in the lithium composite oxide, the rate of Ni to the total number of moles of metal elements other than lithium is 80 percent by mole or more.

7. The non-aqueous electrolyte secondary cell according to claim 1, further comprising a package can which is formed of a metal material containing iron as a primary component and which receives the positive electrode, the negative electrode, and the non-aqueous electrolyte.

8. The non-aqueous electrolyte secondary cell according to claim 7,
wherein the package can has an inside surface which is provided with a nickel plating layer, and
the thickness of the nickel plating layer is 1 μm or less.

9. The non-aqueous electrolyte secondary cell according to claim 1,
wherein R₁ and R₂ are the same.

10. The non-aqueous electrolyte secondary cell according to claim 1,
wherein R₁ is different from R₂.

11. The non-aqueous electrolyte secondary cell according to claim 1,
wherein R₃ contains F.
